(19) United States
(12) Patent Application Publication
(10) Pub. No.: US 2022/0348763 A1
(43) Pub. Date: Nov. 3, 2022

(54) CHAIN EXTENDER MASTERBATCH FOR PET EXTRUSION FOAMING, PREPARATION METHOD THEREFOR, AND USE THEREOF

(71) Applicant: Useon (Nanjing) Extrusion Machinery Co., Ltd., Nanjing City (CN)

(72) Inventors: Zhiqiang CHEN, Nanjing City (CN); Tian XIA, Nanjing City (CN)

(21) Appl. No.: 17/867,203

(22) Filed: Jul. 18, 2022

Related U.S. Application Data
(63) Continuation of application No. PCT/CN2020/084812, filed on Apr. 15, 2020.

(51) Int. Cl. C08L 67/02; C08L 51/00; C08L 23/00; C08J 3/22; C08J 9/12; C08J 9/00

(52) U.S. Cl. CPC C08L 67/02; C08L 51/003; C08L 23/00; C08J 3/22; C08J 9/122; C08J 9/0061; C08L 2205/035; C08L 2205/025; C08L 2310/00; C08L 2203/14; C08J 2201/03; C08J 2203/08; C08J 2203/06; C08J 2367/02; C08J 2467/02; C08J 2423/00; C08J 2451/06

(57) ABSTRACT

The present application relates to a chain extender masterbatch for PET extrusion foaming, preparation method therefor, and a use thereof. The masterbatch is mainly prepared by the following components in parts by weight: 5-30 parts of PMDA, 25-90 parts of PBT, 5-70 parts of POE+POE-g-GMA, in which POE accounts for 0-85% of POE+POE-g-GMA by weight; a melting temperature of PBT is 170-225° C. The preparation method includes melting and mixing the above components at a melting temperature of 180-230° C. and a screw speed of 100-500 rpm, and air cooling strand granulating or air cooling die face granulating. The masterbatch can be used in foaming processes of fiber grade PET, film grade PET, bottle grade PET, engineering plastic grade PET and recycled PET.

### CROSS-REFERENCE TO RELATED APPLICATION

This application is a continuation of PCT application serial no. PCT/CN2020/084812, filed on Apr. 15, 2020. The entirety of PCT application serial no. PCT/CN2020/084812 is hereby incorporated by reference herein and made a part of this specification.

### TECHNICAL FIELD

The present application relates to the technical field of chain extender, and particularly to a chain extender masterbatch for PET extrusion foaming, a preparation method therefor and use thereof.

### BACKGROUND ART

Polyethylene terephthalate (PET) foam materials have excellent heat resistance, heat insulation, water vapor barrier and mechanical properties, environmental performance, low density, and recyclability, which may be used in a plurality of fields and have broad prospects. Further, a continuous process of extruding, foaming, and molding of PET can be realized to meet industrial production requirement.

Commercial PET usually have well-structured backbone and low molecular weight, and meanwhile present low melt strength and melt elasticity, which cannot resist the intense elongational deformation during the cell growth stage in the foaming process. And the formed cells will merge into larger ones or rupture. Therefore, during the process of extrusion foaming of PET, the chain extender is needed to react with an end carboxyl/hydroxyl group of PET for chain extension/branching reaction to increase a possibility of molecular chain entanglement in PET melt, thereby improving the melt strength and foaming property of PET.

PET chain extender is a class of multifunctional organic compound containing an electrophilic group, such as anhydride, epoxide, oxazoline, etc., and the chain extender usually includes one or more of them. Previously, as to the chain extender masterbatch for PET extrusion foaming, a single polymer is generally selected as a carrier of the chain extender: 1) PCT international publication No. WO 95/09884 discloses that polyolefin is selected as polymer carrier, such as PP, PE and copolymers thereof. However, polyolefin such as PP and PE will be severely thermally degraded and there is a poor compatibility between PP, PE and PET under a PET extrusion temperature, which decreases the performance of the final product and stability in a foaming process; 2) European Patent No. EP 2048188 discloses that when ethylene-acrylate-glycidyl methacrylate copolymer is used as a polymer carrier, the prepared chain extender masterbatch has very low softening point that is generally lower than 100° C. During the extrusion foaming process, the chain extender masterbatch will soften when contacting with dried PET (the drying temperature is generally higher than 160° C.), which interferes the material conveying stability in the extruder. Moreover, ethylene-acrylate-glycidyl methacrylate copolymer carrier has low viscosity at the temperature for PET extrusion foaming, which causes the pressure of the reaction system to decrease, being not conducive to PET foaming; 3) U.S. Patent No. US 2006/0293416 discloses that when low melting point polyester is used as the polymer carrier, such as PCL and amorphous PETG, there also exist some problems about degradation of polymer carrier and low viscosity at foaming temperature, which would reduce the crystallinity of the final product, thereby reducing the mechanical properties of the final product.

In recent years, researchers begin to use a bi-component polymer carrier, one of which is usually a high melting point polyester such as PET, and the other is a low melting point polymer. For example, European Patent No. EP 2009043 discloses that polyolefin is adopted as a low melting point component, US Patent No. US 2011130475 discloses that ethylene-acrylate copolymer is adopted as a low melting point component, and Chinese patent No. CN 102056967 discloses that polyester elastomer TPEE is adopted as a low melting point component. However, during preparing a chain extender masterbatch, the high melting point polyester component would react with the chain extender to decrease the chain extension efficiency in the foaming process, so the high melting point polyester component needs to be ground into powder, then the chain extender masterbatch is prepared at the processing temperature of the low melting point component, which undoubtedly increases the complexity of the processing process.

### SUMMARY

In view of the deficiencies in the related technology, firstly, the present application provides a chain extender masterbatch for PET extrusion foaming, which could improve the chain extension efficiency of the chain extender and mechanical properties of foam products. Secondly, the present application provides a preparation method for the chain extender masterbatch for PET extrusion foaming. The method is simple and the obtained foam product has uniform and stable properties. Thirdly, the present application provides a use of the chain extender masterbatch for PET extrusion foaming, which has high adaptability and wide application.

In a first aspect, the present application provides a chain extender masterbatch for PET extrusion foaming, including the following components in parts by weight: 5-30 parts of PMDA, 25-90 parts of PBT, 5-70 parts of POE+POE-g-GMA, in which POE accounts for 0-85% of POE+POE-g-GMA by weight; and a melting temperature of PBT is 170-225° C.

In the above technical solution, pyromellitic dianhydride (PMDA) is adopted as a chain extender in the present application. Pyromellitic dianhydride has a melting point of about 285° C., which is close to the processing temperature of PET, and has better reactivity with PET. PMDA has a functionality of 4, and may quickly react with PET in the extruder. Therefore, PMDA is adopted as an effective chain extender in the present application.

At the cell stabilizing stage of PET extrusion foaming, with the decrease of melt temperature, PET molecular chain begins to crystallize and the rigidity of foaming system is increased, thereby preventing the cell growth. Usually, PET has low crystallization rate, which is not conducive to cell stability. Therefore, polybutylene terephthalate (PBT) with faster crystallization rate is adopted as the carrier of the chain extender in the present application. Polybutylene terephthalate may act as a PET crystallization nucleating agent during cooling to promote PET non-isothermal crystallization, thereby inhibiting cell growing and decreasing the cell size.

In the present application, the melting temperature of PBT component is defined to 170-225° C., which is conducive to decreasing the processing temperature during preparing the masterbatch, then the reaction between the chain extender PMAD and PBT may be avoided. Therefore, the step of grinding PBT component into powder is omitted, and the producing procedure is significantly simplified. During PET extrusion foaming, the degree of thermal decomposition of PBT in the present application is low, moreover, the compatibility between PBT and PET is good, which is helpful to improve the mechanical properties of the foaming products. In addition, comparing with other low melting point polymer carriers, PBT component does not soften when contacting and mixing with dried PET, so that each component may be stably delivered in the feeding stage during PET extrusion foaming. Using chain extender masterbatch in which PBT is the main component, the pressure at the extruder head may be moderate, thereby reducing the influence on quality of the extrusion foaming product.

Glycidyl methacrylate grafted polyolefin elastomer (POE-g-GMA) and polyolefin elastomer (POE) are adopted as dispersion accelerators in the present application, so that the chain extender masterbatch may be dispersed better into the PET matrix during extrusion foaming, thereby improving the stability of extrusion foaming process and uniformity of the foam products. When only POE-g-GMA is adopted as dispersion accelerator, good dispersion may also be achieved, and adding POE to replace a portion of POE-g-GMA can significantly reduce the production cost. Both POE and POE-g-GMA have good temperature resistance, which can reduce the degree of thermal degradation of the masterbatch at PET processing temperature. However, POE and PET have poor compatibility, POE-g-GMA acts as a compatibilizer and improve the compatibility between POE and PET.

In the present application, a low melting point polyester PBT, polyolefin elastomer POE and POE-g-GMA are combined as the carrier polymer of chain extender, which can solve the problems of thermal degradation, compatibility, delivering stability, reaction system pressure and complex machining process, and help improve the chain extension efficiency of the masterbatch and mechanical properties of PET foam products.

In an alternative embodiment, the chain extender masterbatch for PET extrusion foaming includes the following components in parts by weight: 10-20 parts of PMDA, 50-80 parts of PBT, 10-35 parts of POE+POE-g-GMA, in which POE accounts for 60-85% of POE+POE-g-GMA by weight; the melting temperature of PBT is 175-215° C.

In the above technical solution, proportions of PMDA, PBT, and POE+POE-g-GMA are defined to 10-20 parts, 50-80 parts, and 10-35 parts, respectively, such that the proportion of the active ingredient in chain extender masterbatch is increased, which is helpful in improving the chain extension efficiency of the chain extender masterbatch. The content of POE in POE+POE-g-GMA is defined in a range from 60 to 85 percent by weight, which may significantly reduce the cost of the masterbatch due to the low cost of POE. PBT with a melting temperature of 175-215° C. may decrease the thermal degradation degree of PBT and increase the chain extension efficiency of the masterbatch, thereby improving mechanical properties of the foam products. When the temperature of PBT material reached 175-215° C., PBT material begins to melt, and the melt viscosity is decreased, which is conducive to maintain good fluidity and excellent processability. Moreover, PBT will not soften when contacting with the dried PET within above melting temperature range, thereby significantly improving the delivering stability of PBT in the extrusion foaming process.

In an alternative embodiment, the intrinsic viscosity of PBT is 0.75-1.3 dL/g.

In the above technical solution, the intrinsic viscosity of PBT is defined to 0.75-1.3 dL/g, then the melt viscosity may be increased, thereby increasing pressure at the extruder head and further increasing the foaming expansion ratio of PET extruded products. The dispersion uniformity between PBT, POE, and POE-g-GMA will be decreased in masterbatch preparation process, moreover, the melt viscosity will be decreased, and the melt pressure will be unstable, thereby deteriorating the results of PET extrusion foaming, under the condition that the intrinsic viscosity of the PBT is less than 0.75 dL/g. The energy consumption will be increased in PBT preparation process, which is not conducive to the energy saving and environmental protection of material research, under the condition that the intrinsic viscosity of the PBT is greater than 1.3 dL/g.

In an alternative embodiment, the intrinsic viscosity of PBT is 0.90-1.20 dL/g.

In the above technical solution, during PET extrusion foaming, the pressure of the reaction system will be decreased. When the intrinsic viscosity of the PBT is at 0.90-1.20 dL/g, it can ensure that PBT have high intrinsic viscosity. PBT with above intrinsic viscosity may significantly increase the pressure of the extruder head after being added into the extruder, thereby improving the quality of the foam product.

In an alternative embodiment, the melt flow rate of POE is 0.5-5 g/10 min, and the melt flow rate of POE-g-GMA is 1-5 g/10 min.

In the above technical solution, the melt flow rate of POE is defined to 0.5-5 g/10 min and the melt flow rate of POE-g-GMA is defined to 1-5 g/10 min POE and POE-g-GMA with the above melt flow rate range have good processability, which can improve the compatibility between POE and PBT, and can improve the dispersity and compatibility of the masterbatch in the extruder during PET extrusion foaming, thereby improving the stability of foaming process and qualities of the foam products. The masterbatch is difficult to be prepared when the melt flow rate is too high; and the masterbatch is difficult to be uniformly mixed with PET, thereby resulting in uniform dispersion when the melt flow rate is too low.

In an alternative embodiment, the melt flow rate of POE is 0.5-1.5 g/10 min, and the melt flow rate of POE-g-GMA is 2-5 g/10 min.

In the above technical solution, POE and POE-g-GMA with above melt flow rates can further improve the processability and dispersity of the masterbatch in PET system.

In an alternative embodiment, a grafting ratio of GMA in POE-g-GMA is 0.2-5%.

In the above technical solution, the grafting ratio of GMA in POE-g-GMA is defined to 0.2-5% to improve the compatibility between POE-g-GMA and PET matrix and ensure homogeneous foam product, thereby improving the mechanical properties of the foam products.

In an alternative embodiment, the grafting ratio of GMA in POE-g-GMA is 0.5-2%.

In the above technical solution, the grafting ratio of GMA in POE-g-GMA is defined to 0.5-2% to further improve the compatibility between POE-g-GMA and PET matrix and further ensure homogeneous foam product, thereby further improving the mechanical properties of the foam products.

In a second aspect, present application provides a preparation method for the chain extender masterbatch for PET extrusion foaming, including the following steps:

(1) weighing the following components in parts by weight: 5-30 parts of PMDA, 25-90 parts of PBT, 5-70 parts of POE+POE-g-GMA, in which POE accounts for 0-85% of POE+POE-g-GMA; and
(2) feeding above components into an extruder, where a mixing temperature is greater than the melting temperature of PBT by 5-25° C. and lower than a melting temperature of a chain extender by 20-100° C. with a screw speed of 100-500 rpm; and granulating.

In the above technical solution, the above components are mixed at a mixing temperature selected in above method, which can reduce or even avoid the reaction between PBT and chain extender PMDA during preparing the masterbatch. The preparation method for the masterbatch in the present application is simple, and the masterbatch may be made by one-step melt mixing process via an ordinary twin-screw extruder. All components may be fed into a extruder from a main feeding port without a side feeder in the middle of the extruder barrel for feeding powder components, which can reduce the construction cost of the extruder and complexity of the extrusion process.

In a third aspect, the present application provides a use of a chain extender masterbatch for PET extrusion foaming with fiber grade PET, film grade PET, bottle grade PET, engineering plastic grade PET, or recycled PET as raw material. An intrinsic viscosity of PET is 0.5-1.5 dL/g, an end carboxyl group concentration of PET is 15-50 mol/t, an amount of the masterbatch added in the process of PET extrusion foaming is 0.5-10 wt % by mass.

In the above technical solution, the intrinsic viscosities of fiber grade PET, film grade PET, bottle grade PET, engineering plastic grade PET, and recycled PET are between 0.5-1.5 dL/g, the end carboxyl group concentration is 15-50 mol/t. The masterbatch in the present application can be used in PET extrusion foaming process with above different grades of PET with wide range of molecular weight, thereby significantly improving the applicability and convenience of the masterbatch and making homogeneous PET foam products.

In summary, the present application can achieve at least one of the following beneficial technical effects:

1. PBT with low melting point is selected for preparing the chain extender masterbatch in the present application, which can decrease the processing temperature in masterbatch preparation process, effectively avoid the reaction between the chain extender PMAD and PBT, and omit the step of grinding PBT component into powder before being used in preparing the chain extender masterbatch, thereby significantly simplifying the production process. In addition, there is good compatibility between PBT and PET, and PBT will not soften when contacting and mixing with dried PET, so that components can be stably delivered in feeding step during PET extrusion foaming;
2. POE and POE-g-GMA are adopted as dispersion accelerators in the present application, which can improve the compatibility of the masterbatch in the PET extrusion foaming process. Comparing with only adding POE-g-GMA, it can significantly decrease the material cost. The temperature resistance of POE and POE-g-GMA is high enough, and the masterbatch will not suffer thermal degradation at the processing temperature of PET; and
3. During the masterbatch preparation process of the present application, the selected mixing temperature can effectively avoid the reaction between PBT and the chain extender PMDA and improve the chain extension efficiency of the masterbatch. The preparation method for the masterbatch in the present application is simple, and the masterbatch may be produced by one-step melt mixing method via an ordinary twin-screw extruder. All components may be fed into a extruder from a main feeding port without a side feeder in the middle of the extruder barrel for feeding powder components, which can reduce the construction cost of the extruder and complexity of the extrusion process.

### BRIEF DESCRIPTION OF THE DRAWINGS

FIG. 1 is a schematic diagram of the cell morphology of a sample of Application example 9.

FIG. 2 is an elongational rheological curve of a sample of Application example 9 under different elongational strain rate.

### DETAILED DESCRIPTION

The present application is further described in detail below in combination with the FIGs.

PBT is available from Sinopec; POE is available from LG Chemical Company; POE-g-GMA is available from JiaYiRong Compatibilizer Co., Ltd.

### Example 1

A chain extender masterbatch for PET extrusion foaming was prepared by the following steps:

(1) Batching: the following components in parts by weight were weighted: 5 parts of PMDA, 25 parts of PBT, 70 parts of POE-g-GMA. The melting temperature of PBT was 190° C., the intrinsic viscosity of PBT was 1.0 dL/g, the melt flow rate of POE-g-GMA was 2 g/10 min, and the grafting ratio of GMA in POE-g-GMA was 1%; and
(2) The above components were melted and mixed by a twin-screw extruder at 205° C. All components were fed from a main feeding port of the extruder, and subjected to melting, mixing and extrusion through a multi-hole extruder head. The screw diameter of the extruder D was 30 mm, and the length-diameter ratio L/D of the extruder screw was 30-48, which was 40 in this example. The screw speed was 100-500 rpm, which was 200 rpm in this example. The extruded material was air cooled and granulated as the chain extender masterbatch.

### Example 2

A chain extender masterbatch for PET extrusion foaming was prepared by the following steps:

(1) Batching: the following components in parts by weight were weighted: 5 parts of PMDA, 25 parts of PBT, 35 parts of POE, and 35 parts of POE-g-GMA. The melting temperature of PBT was 190° C., the intrinsic viscosity of PBT was 1.0 dL/g, the melt flow rate of POE was 1 g/10 min, the melt flow rate of POE-g-GMA was 2 g/10 min, and the grafting ratio of GMA in POE-g-GMA was 1%; and
(2) The above components were melted and mixed by a twin-screw extruder. All components were fed from a main feeding port of the extruder. The screw diameter of the extruder D was 30 mm, and the length-diameter ratio L/D of the extruder screw was 48, the mixing temperature was 205° C., and the screw speed was 200 rpm. The extruded material was air cooled and granulated.

### Example 3

A chain extender masterbatch for PET extrusion foaming was prepared by the following steps:

(1) Batching: the following components in parts by weight were weighted: 10 parts of PMDA, 40 parts of PBT, 30 parts of POE, and 20 parts of POE-g-GMA. The melting temperature of PBT was 190° C., the intrinsic viscosity of PBT was 1.0 dL/g, the melt flow rate of POE was 1 g/10 min and that of POE-g-GMA was 2 g/10 min, and the grafting ratio of GMA in POE-g-GMA was 1%; and
(2) The above components were melted and mixed by a twin-screw extruder. All components were fed from a main feeding port of the extruder. The screw diameter of the extruder D was 30 mm, the length-diameter ratio L/D of the extruder screw was 48, the mixing temperature was 205° C., and the screw speed was 200 rpm. The extruded material was air cooled and granulated.

### Example 4

A chain extender masterbatch for PET extrusion foaming was prepared by the following steps:

(1) Batching: the following components in parts by weight were weighted: 10 parts of PMDA, 50 parts of PBT, 24 parts of POE, and 16 parts of POE-g-GMA. The melting temperature of PBT was 190° C., the intrinsic viscosity of PBT was 1.0 dL/g, the melt flow rate of POE was 1 g/10 min, the melt flow rate of POE-g-GMA was 2 g/10 min, and the grafting ratio of GMA in POE-g-GMA was 1%; and
(2) The above components were melted and mixed by a twin-screw extruder. All components were fed from a main feeding port of the extruder. The screw diameter of the extruder D was 30 mm, the length-diameter ratio L/D of the extruder screw was 48, the mixing temperature was 205° C., and the screw speed was 200 rpm. The extruded material was air cooled and granulated.

### Example 5

A chain extender masterbatch for PET extrusion foaming was prepared by the following steps:

(1) Batching: the following components in parts by weight were weighted: 10 parts of PMDA, 60 parts of PBT, 18 parts of POE, and 12 parts of POE-g-GMA. The melting temperature of PBT was 190° C., the intrinsic viscosity of PBT was 1.0 dL/g, the melt flow rate of POE was 1 g/10 min, the melt flow rate of POE-g-GMA was 2 g/10 min, and the grafting ratio of GMA in POE-g-GMA was 1%; and
(2) The above components were melted and mixed by a twin-screw extruder. All components were fed from a main feeding port of the extruder. The screw diameter of the extruder D was 30 mm, the length-diameter ratio L/D of the extruder screw was 48, the mixing temperature was 205° C., and the screw speed was 200 rpm. The extruded material was air cooled and granulated.

### Example 6

A chain extender masterbatch for PET extrusion foaming was prepared by the following steps:

(1) Batching: the following components in parts by weight were weighted: 10 parts of PMDA, 70 parts of PBT, 12 parts of POE, and 8 parts of POE-g-GMA. The melting temperature of PBT was 190° C., the intrinsic viscosity of PBT was 1.0 dL/g, the melt flow rate of POE was 1 g/10 min, the melt flow rate of POE-g-GMA was 2 g/10 min, and the grafting ratio of GMA in POE-g-GMA was 1%; and
(2) The above components were melted and mixed by a twin-screw extruder. All components were fed from a main feeding port of the extruder. The screw diameter of the extruder D was 30 mm, the length-diameter ratio L/D of the extruder screw was 48, the mixing temperature was 205° C., and the screw speed was 200 rpm. The extruded material was air cooled and granulated.

### Example 7

A chain extender masterbatch for PET extrusion foaming was prepared by the following steps:

(1) Batching: the following components in parts by weight were weighted: 10 parts of PMDA, 80 parts of PBT, 6 parts of POE, and 4 parts of POE-g-GMA. The melting temperature of PBT was 190° C., the intrinsic viscosity of PBT was 1.0 dL/g, the melt flow rate of POE was 1 g/10 min, the melt flow rate of POE-g-GMA was 2 g/10 min, and the grafting ratio of GMA in POE-g-GMA was 1%; and
(2) The above components were melted and mixed by a twin-screw extruder. All components were fed from a main feeding port of the extruder. The screw diameter of the extruder D was 30 mm, the length-diameter ratio L/D of an extruder screw was 48, the mixing temperature was 205° C., and the screw speed was 200 rpm. The extruded material was air cooled and granulated.

### Example 8

A chain extender masterbatch for PET extrusion foaming was prepared by the following steps:

(1) Batching: the following components in parts by weight were weighted: 15 parts of PMDA, 60 parts of PBT, 15 parts of POE, and 10 parts of POE-g-GMA. The melting temperature of PBT was 190° C., the intrinsic viscosity of PBT was 1.0 dL/g, the melt flow rate of POE was 1 g/10 min, the melt flow rate of POE-g-GMA was 2 g/10 min, and the grafting ratio of GMA in POE-g-GMA was 1%; and
(2) The above components were melted and mixed by a twin-screw extruder. All components were fed from a main feeding port of the extruder. The screw diameter of the extruder D was 30 mm, the length-diameter ratio L/D of the extruder screw was 48, the mixing temperature was 205° C., and the screw speed was 200 rpm. The extruded material was air cooled and granulated.

### Example 9

A chain extender masterbatch for PET extrusion foaming was prepared by the following steps:

(1) Batching: the following components in parts by weight were weighted: 20 parts of PMDA, 60 parts of PBT, 12 parts of POE, and 8 parts of POE-g-GMA. The melting temperature of PBT was 190° C., the intrinsic viscosity of PBT was 1.0 dL/g, the melt flow rate of POE was 1 g/10 min, the melt flow rate of POE-g-GMA was 2 g/10 min, and the grafting ratio of GMA in POE-g-GMA was 1%; and
(2) The above components were melted and mixed by a twin-screw extruder. All components were fed from a main feeding port of the extruder. The screw diameter of the extruder D was 30 mm, the length-diameter ratio L/D of the extruder screw was 48, the mixing temperature was 205° C., and the screw speed was 200 rpm. The extruded material was air cooled and granulated.

### Example 10

A chain extender masterbatch for PET extrusion foaming was prepared by the following steps:

(1) Batching: the following components in parts by weight were weighted: 30 parts of PMDA, 50 parts of PBT, 12 parts of POE, and 8 parts of POE-g-GMA. The melting temperature of PBT was 190° C., the intrinsic viscosity of PBT was 1.0 dL/g, the melt flow rate of POE was 1 g/10 min, the melt flow rate of POE-g-GMA was 2 g/10 min, and the grafting ratio of GMA in POE-g-GMA was 1%; and
(2) The above components were melted and mixed by a twin-screw extruder. All components were fed from a main feeding port of the extruder. The screw diameter of the extruder D was 30 mm, the length-diameter ratio L/D of the extruder screw was 48, the mixing temperature was 205° C., and the screw speed was 200 rpm. The extruded material was air cooled and granulated.

### Example 11

The chain extender masterbatch for PET extrusion foaming of example 11 is same as example 9 except that PBT was prepared by the following steps:

(1) dimethyl terephthalate, 1,4-butanediol, tetrabutyl titanate, and cyclohexanedimethanol in a certain proportion were added into a polymerization reactor, and were heated to 180° C. under stirring at N₂ atmosphere, for transesterification reaction for 1.5 hr, and a by-product methanol was distilled. The molar ratio of dimethyl terephthalate to diol (1,4-butanediol+cyclohexanedimethanol) was 1:1.2, the mole percentage of cyclohexanedimethanol in diol was 5%, and the concentration of tetrabutyl titanate was 650 ppm.
(2) The distillation unit was turned off, and a vacuum system was turned on, then the system pressure was decreased to lower than 100 Pa, and the reactor was heated rapidly to 250° C. under stirring for carrying out a polycondensation reaction for 1.5 hr; and
(3) the reaction was stopped, then the resultant material was subjected to water cooling, and granulating to obtain PBT. The melting temperature of the obtained PBT was 190° C. The preparation method had advantages of fast reaction speed, environmentally friendly by-products, and the obtained PBT got better dispersion and compatibility in PET system.

### Example 12

The chain extender masterbatch for PET extrusion foaming in example 12 was same as Example 11 except that the mole percentage of cyclohexanedimethanol in diol was 10%, the melting temperature of the prepared PBT was 185° C., and the mixing temperature was 200° C. at mixing step.

### Example 13

The chain extender masterbatch for PET extrusion foaming in example 13 was same as Example 11 except that a mole percentage of cyclohexanedimethanol in diol was 20%, the melting temperature of the prepared PBT was 176° C., and the mixing temperature was 190° C. at mixing step.

### Application Example 1

PET foam board was prepared through PET extrusion foaming by a twin-screw extruder. The screw diameter D of the extruder was 75 mm, and the length-diameter ratio L/D of the extruder screw was 40. A static mixer and a multi-hole foaming die with a width of 610 mm and a thickness of 40 mm were successively installed downstream of the extruder. After exiting from the die, the extrudate was pulled into a calibration machine, thereby obtaining a foamed PET board with rectangular cross section.

Fiber grade PET (the intrinsic viscosity IV was 0.65 dL/g, and the end carboxyl group concentration was 25 mol/t) and the chain extender masterbatch prepared in Example 1 were used for extrusion foaming, in which PET needed to be dried at 165° C. for 4 h, the output of the twin-screw extruder was 100 kg/hr, the feeding rate of PET was 95.5 kg/hr, and the feeding rate of the chain extender masterbatch was 4.5 kg/hr. PET and the chain extender masterbatch were fed separately by a feeder, and a blowing agent can be supercritical fluid (such as CO₂, N₂), alkane (such as butane, cyclopentane, etc.), Freon, or mixture of two or more of above blowing agents. In this application example, cyclopentane was selected as the blowing agent, which was injected into the extruder at a rate of 3 kg/hr through an injection pump. The setting temperatures during the extrusion process were shown in the following table:

| Extrusion section | Temperature(° C.) |
|---|---|
| Feeding section | 260 |
| Melting section | 265-280 |
| Mixing section | 280-290 |
| Metering section | 260-280 |
| Static mixer | 260-280 |
| Die | 250-275 |

PET foam board with uniform cell and stable performance may be continuously and stably prepared by the above preparation process.

### Application Example 2

The PET extrusion foamed board of Application example 2 was same as Application example 1 except that the chain extender masterbatch prepared in Example 2 was used.

### Application Example 3

The PET extrusion foamed board of Application example 3 was same as Application example 1 except that the chain extender masterbatch prepared in Example 3 was used.

### Application Example 4

The PET extrusion foamed board of Application example 4 was same as Application example 1 except that the chain extender masterbatch prepared in Example 4 was used.

### Application Example 5

The PET extrusion foamed board of Application example 5 was same as Application example 1 except that the chain extender masterbatch prepared in Example 5 was used.

### Application Example 6

The PET extrusion foamed board of Application example 6 was same as Application example 1 except that the chain extender masterbatch prepared in Example 6 was used.

### Application Example 7

The PET extrusion foamed board of Application example 7 was same as Application example 1 except that the chain extender masterbatch prepared in Example 7 was used.

### Application Example 8

The PET extrusion foamed board of Application example 8 was same as Application example 1 except that the chain extender masterbatch prepared in Example 8 was used.

### Application Example 9

The PET extrusion foamed board of Application example 9 was same as Application example 1 except that the chain extender masterbatch prepared in Example 9 was used.

### Application Example 10

The PET extrusion foamed board of Application example 10 was same as Application example 1 except that the chain extender masterbatch prepared in Example 10 was used.

### Application Example 11

The PET extrusion foamed board of Application example 11 was same as Application example 1 except that the chain extender masterbatch prepared in Example 11 was used.

### Application Example 12

The PET extrusion foamed board of Application example 12 was same as Application example 1 except that the chain extender masterbatch prepared in Example 12 was used.

### Application Example 13

The PET extrusion foamed board of Application example 13 was same as Application example 1 except that the chain extender masterbatch prepared in Example 13 was used.

### Application Example 14

The PET extrusion foamed board of Application example 14 was made from the granules prepared by recycling and granulating PET beverage bottles (the intrinsic viscosity IV was 0.68 dL/g, and the end carboxyl group concentration was 35 mol/t) and the chain extender masterbatch prepared in Example 9 by the same extrusion equipment and foaming process as in Application Example 1 for PET extrusion foaming, so that the PET foamed board with uniform cell structure was continuously and stably prepared.

### Application Example 15

The PET extraction foamed board of Application example 15 was prepared by a tandem extruder for PET extrusion foaming. The first stage twin-screw extruder had a screw diameter D of 52 mm and a length-diameter ratio L/D of 40, and the second stage single screw extruder had a screw diameter D of 90 mm and a length-diameter ratio L/D of 24. A static mixer and a multi-hole foaming die with a width of 35 mm and a thickness of 20 mm were successively installed downstream of the extruder. After exiting from the die, the extrudate was pulled into a calibration machine, thereby obtaining a foamed PET board with rectangular cross section.

Bottle grade PET (the intrinsic viscosity IV was 0.8 dL/g, and the end carboxyl group concentration was 30 mol/t) and the chain extender masterbatch prepared in Example 9 were used for extrusion foaming, in which PET needed to be dried at 165° C. for 4 hr, the output of the twin-screw extruder was 60 kg/hr, the feeding rate of PET was 58.5 kg/hr, and the feeding rate of the chain extender masterbatch was 1.5 kg/hr. PET and the chain extender masterbatch were fed separately by a feeder. In the example. Supercritical CO₂ was adopted as the blowing agent, which was injected into the extruder at a speed of 2.5 kg/hr through an injection pump. The temperatures during the extrusion process were shown in the following table:

| Extrusion section | | Temperature(° C.) |
|---|---|---|
| First stage/twin-screw extruder | Feeding section | 260 |
| | Melting section | 265-280 |
| | Mixing section | 280-290 |
| | Metering section | 260-280 |

| | |
|---|---|
| Second stage/single screw extruder | 220-250 |
| Static mixer | 250-270 |
| Die | 250-265 |

PET foamed board with uniform cell may be continuously and stably prepared by the above preparation process.

### Application Example 16

The PET extrusion foamed board of Application example 16 was prepared by the following steps:

(1) the chain extender masterbatch was prepared according to the steps in Example 9 except that the melting temperature of PBT was 170° C., and the mixing temperature was 185° C.; and
(2) the foamed board was prepared according to the steps in Application Example 1, in which the chain extender masterbatch prepared in step (1) was used.

### Application Example 17

The PET extrusion foamed board of Application example 17 was same as Application example 16 except that the melting temperature of PBT was 175° C., and the mixing temperature was 190° C.

### Application Example 18

The PET extrusion foamed board of Application example 18 was same as Application example 16 except that the melting temperature of PBT was 215° C., and the mixing temperature was 225° C.

### Application Example 19

The PET extrusion foamed board of Application example 19 was same as Application example 16 except that the melting temperature of PBT was 225° C., and the mixing temperature was 230° C.

### Application Example 20

The PET extrusion foamed board of Application example 20 was prepared by the following steps:

(1) the chain extender masterbatch was prepared according to the steps in Example 9 except that the intrinsic viscosity of PBT was 0.75 dL/g; and
(2) the foamed board was prepared according to the steps in Application example 1, in which the chain extender masterbatch prepared in step (1) was used.

### Application Example 21

The PET extrusion foamed board of Application example 21 was same as Application example 20 except that the intrinsic viscosity of PBT was 0.9 dL/g.

### Application Example 22

The PET extrusion foamed board of Application example 22 was same as Application example 20 except that the intrinsic viscosity of PBT was 1.2 dL/g.

### Application Example 23

The PET extrusion foamed board of Application example 23 was same as Application example 20 except that the intrinsic viscosity of PBT was 1.3 dL/g.

### Application Example 24

The PET extrusion foamed board of Application example 24 was same as Application example 9 except that the grafting ratio of GMA in POE-g-GMA was 0.2%.

### Application Example 25

The PET extrusion foamed board of Application example 25 was same as Application example 24 except that the grafting ratio of GMA in POE-g-GMA was 0.5%.

### Application Example 26

The PET extrusion foamed board of Application example 26 was same as Application example 24 except that the grafting ratio of GMA in POE-g-GMA was 2%.

### Application Example 27

The PET extrusion foamed board of Application example 27 was same as Application example 24 except that the grafting ratio of GMA in POE-g-GMA was 5%.

### Comparative Example 1

The PET extrusion foamed board of Comparative example 1 was prepared by the following steps:

(1) the chain extender masterbatch was prepared according to the steps of Example 9 except that the melting temperature of PBT was 165° C., and the mixing temperature was 180° C.; and
(2) the foamed board was prepared according to the steps of Application Example 1, in which the chain extender masterbatch prepared in step (1) was used.

### Comparative Example 2

The PET extrusion foamed board of Comparative example 2 was prepared by the following steps:

(1) the chain extender masterbatch was prepared according to the steps of Example 9 except that the melting temperature of PBT was 230° C., and the mixing temperature was 240° C.; and
(2) the foamed board was prepared according to the steps of Application Example 1, in which the chain extender masterbatch prepared in step (1) was used.

### Comparative Application Example 1

The PET extrusion foamed board of Comparative application example 1 was prepared by the following steps:

(1) the chain extender masterbatch was prepared according to the steps of Example 9 except that the intrinsic viscosity of PBT was 0.6 dL/g; and
(2) the foamed board was prepared according to the steps of Application example 1, in which the chain extender masterbatch prepared in step (1) was used.

### Comparative Application Example 2

The PET extrusion foamed board of Comparative application example 2 was prepared by the following steps:

(1) the chain extender masterbatch was prepared according to the steps of Example 9 except that the intrinsic viscosity of PBT was 1.4 dL/g; and
(2) the foamed board was prepared according to the steps of Application example 1, in which the chain extender masterbatch prepared in step (1) was used.

### Comparative Application Example 3

The PET extrusion foamed board of Comparative application example 3 was prepared by the following steps:

(1) the chain extender masterbatch was prepared according to the steps of Example 9 except that the melt flow rate of POE was 0.2 g/10 min, and the melt flow rate of POE-g-GMA was 0.5 g/10 min; and
(2) the foamed board was prepared according to the steps of Application example 1, in which the chain extender masterbatch prepared in step (1) was used.

### Comparative Application Example 4

The PET extrusion foamed board of Comparative application example 4 was prepared by the following steps:

(1) the chain extender masterbatch was prepared according to the steps of Example 9 except that the melt flow rate of POE was 6 g/10 min, and the melt flow rate of POE-g-GMA was 6 g/10 min; and
(2) the foamed board was prepared according to the steps of Application example 1, in which the chain extender masterbatch prepared in step (1) was used.

### Comparative Application Example 5

The PET extrusion foamed board of Comparative application example 5 was prepared by the following steps:

(1) the chain extender masterbatch was prepared according to the steps of Example 9 except that the grafting ratio of GMA in POE-g-GMA was 0.1%; and
(2) the foamed board was prepared according to the steps of Application example 1, in which the chain extender masterbatch prepared in step (1) was used.

### Comparative Application Example 6

The PET extrusion foamed board of Comparative application example 6 was prepared by the following steps:

(1) the chain extender masterbatch was prepared according to the steps of Example 9 except that the grafting ratio of GMA in POE-g-GMA was 7%; and
(2) the foamed board was prepared according to the steps of Application example 1, in which the chain extender masterbatch prepared in step (1) was used.

Testing Methods

(1) Apparent density: the foamed boards of the application examples and comparative examples were tested according to ISO 845 standard for the apparent density;
(2) Tensile strength: the foamed boards of the application examples and comparative examples were tested according to ASTMC297 standard for the tensile strength;
(3) Compressive strength: the foamed boards of the application examples and comparative examples were tested according to ISO 844 standard for the compressive strength;
(4) Shear strength: the foamed boards of the application examples and comparative examples were tested according to ISO 1922 standard for the shear strength;
(5) Intrinsic viscosity: according to GB/T14190, solvent was a mixture of phenol and tetrachloroethane in a weight ratio of 1:1, and the testing temperature was 25±0.1° C.;
(6) Cell morphology: the sample of Application example 9 was observed by scanning electron microscope (SEM) with a magnification of 200; and
(7) Processing condition: the material delivering and extruder head pressure in the masterbatch preparation stage and PET foaming stage were observed.

Testing results were shown in the following table:

| | Apparent | Tensile | Compressive | Shear | Intrinsic | |
|---|---|---|---|---|---|---|
| | density | strength | strength | strength | viscosity | |
| Samples | (kg/m³) | (MPa) | (MPa) | (MPa) | (dL/g) | Processing condition |
| Application | 100 ± 5 | 2.41 | 1.64 | 0.9 | 1.0 | Masterbatch preparation |
| example 1 | | | | | | stage: uniform |
| | | | | | | dispersion; stable |
| | | | | | | foaming material |
| | | | | | | delivering and moderate |
| | | | | | | extruder head pressure |
| Application | | 2.41 | 1.64 | 0.9 | 1.0 | Masterbatch preparation |
| example 2 | | | | | | stage: uniform |
| | | | | | | dispersion; stable |
| | | | | | | foaming material |
| | | | | | | delivering and moderate |
| | | | | | | extruder head pressure |
| Application | | 2.47 | 1.70 | 1.2 | 1.2 | Masterbatch preparation |
| example 3 | | | | | | stage: uniform |
| | | | | | | dispersion; stable |
| | | | | | | foaming material |
| | | | | | | delivering and moderate |
| | | | | | | extruder head pressure |
| Application | | 2.48 | 1.72 | 1.2 | 1.2 | Masterbatch preparation |
| example 4 | | | | | | stage: uniform |
| | | | | | | dispersion; stable |
| | | | | | | foaming material |
| | | | | | | delivering and moderate |
| | | | | | | extruder head pressure |
| Application | | 2.49 | 1.74 | 1.2 | 1.3 | Masterbatch preparation |
| example 5 | | | | | | stage: uniform |
| | | | | | | dispersion; stable |
| | | | | | | foaming material |
| | | | | | | delivering and moderate |
| | | | | | | extruder head pressure |
| Application | | 2.50 | 1.77 | 1.3 | 1.3 | Masterbatch preparation |
| example 6 | | | | | | stage: uniform |
| | | | | | | dispersion; stable |
| | | | | | | foaming material |
| | | | | | | delivering and moderate |
| | | | | | | extruder head pressure |
| Application | | 2.46 | 1.69 | 1.1 | 1.2 | Masterbatch preparation |
| example 7 | | | | | | stage: uniform |
| | | | | | | dispersion; stable |
| | | | | | | foaming material |
| | | | | | | delivering and moderate |
| | | | | | | extruder head pressure |
| Application | | 2.53 | 1.79 | 1.3 | 1.4 | Masterbatch preparation |
| example 8 | | | | | | stage: uniform |
| | | | | | | dispersion; stable |
| | | | | | | foaming material |
| | | | | | | delivering and moderate |
| | | | | | | extruder head pressure |
| Application | | 2.57 | 1.82 | 1.4 | 1.5 | Masterbatch preparation |
| example 9 | | | | | | stage: uniform |
| | | | | | | dispersion; stable |
| | | | | | | foaming material |
| | | | | | | delivering and moderate |
| | | | | | | extruder head pressure |
| Application | | 2.55 | 1.78 | 1.3 | 1.4 | Masterbatch preparation |
| example 10 | | | | | | stage: uniform |
| | | | | | | dispersion; stable |
| | | | | | | foaming material |
| | | | | | | delivering and moderate |
| | | | | | | extruder head pressure |
| Application | | 2.60 | 1.85 | 1.5 | 1.6 | Masterbatch preparation |
| example 11 | | | | | | stage: uniform |
| | | | | | | dispersion; stable |
| | | | | | | foaming material |
| | | | | | | delivering and moderate |
| | | | | | | extruder head pressure |
| Application | | 2.63 | 1.87 | 1.6 | 1.7 | Masterbatch preparation |
| example 12 | | | | | | stage: uniform |
| | | | | | | dispersion; stable |
| | | | | | | foaming material |
| | | | | | | delivering and moderate |
| | | | | | | extruder head pressure |
| Application | | 2.62 | 1.83 | 1.5 | 1.6 | Masterbatch preparation |
| example 13 | | | | | | stage: uniform |
| | | | | | | dispersion; stable |
| | | | | | | foaming material |
| | | | | | | delivering and moderate |
| | | | | | | extruder head pressure |
| Application | | 2.56 | 1.78 | 1.3 | 1.5 | Masterbatch preparation |
| example 14 | | | | | | stage: uniform |
| | | | | | | dispersion; stable |
| | | | | | | foaming material |
| | | | | | | delivering and moderate |
| | | | | | | extruder head pressure |
| Application | | 2.58 | 1.79 | 1.4 | 1.5 | Masterbatch preparation |
| example 15 | | | | | | stage: uniform |
| | | | | | | dispersion; stable |
| | | | | | | foaming material |
| | | | | | | delivering and moderate |
| | | | | | | extruder head pressure |
| Application | | 2.48 | 1.72 | 1.2 | 1.2 | Masterbatch preparation |
| example 16 | | | | | | stage: uniform |
| | | | | | | dispersion; stable |
| | | | | | | foaming material |
| | | | | | | delivering and moderate |
| | | | | | | extruder head pressure |
| Application | | 2.53 | 1.76 | 1.3 | 1.3 | Masterbatch preparation |
| example 17 | | | | | | stage: uniform |
| | | | | | | dispersion; stable |
| | | | | | | foaming material |
| | | | | | | delivering and moderate |
| | | | | | | extruder head pressure |
| Application | | 2.55 | 1.81 | 1.3 | 1.4 | Masterbatch preparation |
| example 18 | | | | | | stage: uniform |
| | | | | | | dispersion; stable |
| | | | | | | foaming material |
| | | | | | | delivering and moderate |
| | | | | | | extruder head pressure |
| Application | | 2.50 | 1.72 | 1.3 | 1.3 | Masterbatch preparation |
| example 19 | | | | | | stage: uniform |
| | | | | | | dispersion; stable |
| | | | | | | foaming material |
| | | | | | | delivering and moderate |
| | | | | | | extruder head pressure |
| Application | | 2.53 | 1.73 | 1.2 | 1.3 | Masterbatch preparation |
| example 20 | | | | | | stage: uniform |
| | | | | | | dispersion; stable |
| | | | | | | foaming material |
| | | | | | | delivering and moderate |
| | | | | | | extruder head pressure |
| Application | | 2.55 | 1.78 | 1.3 | 1.4 | Masterbatch preparation |
| example 21 | | | | | | stage: uniform |
| | | | | | | dispersion; stable |
| | | | | | | foaming material |
| | | | | | | delivering and moderate |
| | | | | | | extruder head pressure |
| Application | | 2.55 | 1.79 | 1.3 | 1.4 | Masterbatch preparation |
| example 22 | | | | | | stage: uniform |
| | | | | | | dispersion; stable |
| | | | | | | foaming material |
| | | | | | | delivering and moderate |
| | | | | | | extruder head pressure |
| Application | | 2.54 | 1.75 | 1.2 | 1.4 | Masterbatch preparation |
| example 23 | | | | | | stage: uniform |
| | | | | | | dispersion; stable |
| | | | | | | foaming material |
| | | | | | | delivering and moderate |
| | | | | | | extruder head pressure |
| Application | | 2.53 | 1.74 | 1.3 | 1.3 | Masterbatch preparation |
| example 24 | | | | | | stage: uniform |
| | | | | | | dispersion; stable |
| | | | | | | foaming material |
| | | | | | | delivering and moderate |
| | | | | | | extruder head pressure |
| Application | | 2.55 | 1.77 | 1.4 | 1.4 | Masterbatch preparation |
| example 25 | | | | | | stage: uniform |
| | | | | | | dispersion; stable |
| | | | | | | foaming material |
| | | | | | | delivering and moderate |
| | | | | | | extruder head pressure |
| Application | | 2.55 | 1.78 | 1.4 | 1.4 | Masterbatch preparation |
| example 26 | | | | | | stage: uniform |
| | | | | | | dispersion; stable |
| | | | | | | foaming material |
| | | | | | | delivering and moderate |
| | | | | | | extruder head pressure |
| Application | | 2.53 | 1.75 | 1.3 | 1.3 | Masterbatch preparation |
| example 27 | | | | | | stage: uniform |
| | | | | | | dispersion; stable |
| | | | | | | foaming material |
| | | | | | | delivering and moderate |
| | | | | | | extruder head pressure |
| Comparative | | 2.25 | 1.51 | 0.7 | 1.0 | Masterbatch preparation |
| example 1 | | | | | | stage: uniform |
| | | | | | | dispersion; stable |
| | | | | | | foaming material |
| | | | | | | delivering and moderate |
| | | | | | | extruder head pressure |
| Comparative | | 2.29 | 1.53 | 0.8 | 1.0 | Masterbatch preparation |
| example 2 | | | | | | stage: uniform |
| | | | | | | dispersion; stable |
| | | | | | | foaming material |
| | | | | | | delivering and moderate |
| | | | | | | extruder head pressure |
| Comparative | | 2.47 | 1.70 | 1.1 | 1.0 | Masterbatch preparation |
| application | | | | | | stage: non-uniform |
| example 1 | | | | | | dispersion; unstable |
| | | | | | | foaming material |
| | | | | | | delivering and moderate |
| | | | | | | extruder head pressure |
| Comparative | | 2.53 | 1.76 | 1.4 | 1.5 | Masterbatch preparation |
| application | | | | | | stage: uniform |
| example 2 | | | | | | dispersion; stable |
| | | | | | | foaming material |
| | | | | | | delivering and moderate |
| | | | | | | extruder head pressure |
| Comparative | | 2.53 | 1.74 | 1.2 | 1.3 | Masterbatch preparation |
| application | | | | | | stage: uniform |
| example 3 | | | | | | dispersion; not stable |
| | | | | | | enough foaming |
| | | | | | | material delivering and |
| | | | | | | moderate extruder head |
| | | | | | | pressure |
| Comparative | | 2.54 | 1.76 | 1.3 | 1.4 | Difficult to prepare |
| application | | | | | | masterbatch; stable |
| example 4 | | | | | | foaming material |
| | | | | | | delivering and moderate |
| | | | | | | extruder head pressure |
| Comparative | | 2.49 | 1.71 | 1.2 | 1.3 | Difficult to prepare |
| application | | | | | | masterbatch; stable |
| example 5 | | | | | | foaming material |
| | | | | | | delivering and moderate |
| | | | | | | extruder head pressure |
| Comparative | | 2.51 | 1.76 | 1.3 | 1.4 | Easy to prepare |
| application | | | | | | masterbatch; uniform |
| example 6 | | | | | | dispersion; not stable |
| | | | | | | enough foaming |
| | | | | | | material delivering; |
| | | | | | | moderate extruder head |
| | | | | | | pressure |

It can be seen from the above table that, the PET foam boards prepared by each application example of the present application had high tensile strength, compressive strength and shear strength, and excellent mechanical properties. As can be seen that the chain extender masterbatches prepared in Examples 1-10 had both excellent dispersity and compatibility in PET foaming system, so that the masterbatch had excellent chain extension efficiency, thereby preparing the PET foam board with low density and excellent mechanical properties. In Examples 11-13, the PBT components were self-made, and the preparation method had advantages of fast reaction speed, environmentally friendly by-products, and the obtained PBT got better dispersion and compatibility in PET system. The details can be seen from the testing results of Application examples 11-13.

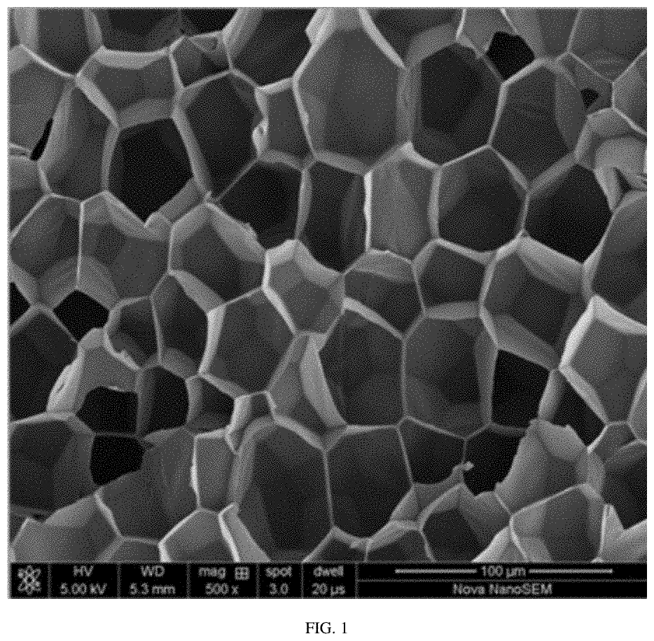

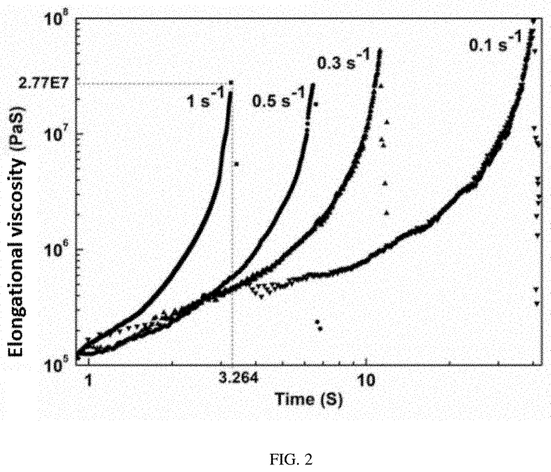

The foam board of Application example 9 had excellent mechanical property. The cell structure of the sample of Application example 9 was observed by SEM. It can be seen from FIG. 1, the sample of Application example 9 had uniform and stable cell, which was conducive to prepare the foamed board with low density and excellent mechanical properties. In addition, it can be seen from FIG. 2 that, the sample of Application example 9 had significant strain hardening effect under different elongational strain rates, which indicated that the melt strength of the PET materials was improved, and the masterbatch had higher chain extension efficiency.

In Application examples 11-13, using the self-made PBT in which cyclohexanedimethanol was used to replace part of 1,4-butanediol destroyed the regularity of PBT molecular chain. PBT components with different melting temperatures were prepared. It can be seen that from the testing results, the mechanical properties of Application examples 11-13 were better than that of Application examples 1-10, so it can be seen that a self-made PBT had batter dispersity in PET system, thereby the mechanical properties of the PET foamed boards can be further improved.

In Application examples 16-19, the melting temperatures of PBT were preferred at 175-215° C., then the mechanical property of PET was the best. In Application examples 20-23, the intrinsic viscosities of PBT were preferred at 0.9-1.2 dL/g, then the mechanical property of the PET extrusion foamed board was the best. In Application examples 24-27, the grafting ratios of GMA in POE-g-GMA were 0.9-1.2 dL/g, and mechanical property of PET extrusion foamed board was the best.

In Comparative examples 1-2, when the melting temperature of PBT was 165° C., PBT would undergo thermal decomposition during PET extrusion foaming, to reduce the chain extension efficiency of the masterbatch. When the melting temperature of PBT was 230° C., PBT would partially react with PMDA during the preparation process of masterbatch, which also can decrease the chain extension efficiency of the masterbatch, and thereby further significantly decreasing the mechanical properties of PET extrusion foamed boards.

In Comparative application examples 1-2, when the intrinsic viscosities of PBT was 0.6 dL/g, the masterbatch was difficult to prepare. The melt pressure at the extrusion die fluctuated greatly, and the raw material delivering was not stable enough during PET foaming process, which would eventually decrease the mechanical properties of the foamed boards. When the intrinsic viscosity of PBT was 1.4 dL/g, PBT was difficult to prepare and the energy consumption was high.

In Comparative application examples 3-4, when POE and POE-g-GMA had low melt flow rates, the masterbatch had poor dispersion in PET foaming system, and the foaming materials had not stable enough delivering, as a result, the mechanical properties of PET foamed boards will be affected. When POE and POE-g-GMA had high melt flow rates, an excessive fluidity caused overflow, as a result, the masterbatch was difficult to be granulated, and thereby finally affecting the mechanical properties of PET foamed boards.

In Comparative application examples 5-6, when the grafting ratio of GMA in POE-g-GMA was 0.1%, the particle spacing of rubber phases in PBT system was larger than the critical molecular spacing, which would make the masterbatch preparation difficult, and the brittle-ductile transition of the foamed board cannot be achieved. As the grafting rate of GMA in POE-g-GMA increased, the particle size of the rubber phase became smaller and the rubber phase was more uniformly dispersed. When the grafting rate of GMA in POE-g-GMA reached 7%, crosslinking is easy to occur in PET extrusion foaming system, which affects the stability of foaming material delivering.

The chain extender masterbatch in the present application can also be introduced other kinds of processing aids, such as heat stabilizers, nucleating agents, flame retardants, etc. The flame retardants included halogen, phosphorus and inorganic compounds. The nucleating agents included talc, nanoclay and silicon dioxide.

Apparatus used during the PET extrusion foaming process includes but not limited to a twin-screw extruder, and actually may adopt all forms of extrusion foaming units, such as a single-screw extruder, a twin-screw extruder and a tandem extruder (the first stage was a twin-screw extruder and the second stage was a single-screw extruder or both the first and second stages were single-screw extruders).

The above are preferred embodiments of the present application, which are not intended to limit the protection scope of the present application. Therefore, all equivalent changes made according to the structure, shape and principle of the present application should be within the protection scope of the present application.

What is claimed is:

1. A chain extender masterbatch for polyethylene terephthalate (PET) extrusion foaming, comprising the following components in parts by weight: 5-30 parts of pyromellitic dianhydride (PMDA), 25-90 parts of polybutylene terephthalate (PBT), and 5-70 parts of polyolefin elastomer plus glycidyl methacrylate grafted polyolefin elastomer (POE+POE-g-GMA), wherein polyolefin elastomer (POE) accounts for 0-85% of the POE+POE-g-GMA by weight; and a melting temperature of the PBT is 170-225° C.

2. The chain extender masterbatch for PET extrusion foaming according to claim 1, comprising the following components in parts by weight: 10-20 parts of the PMDA, 50-80 parts of the PBT, and 10-35 parts of the POE+POE-g-GMA, wherein the POE accounts for 60-85% of the POE+POE-g-GMA by weight; and the melting temperature of the PBT is 175-215° C.

3. The chain extender masterbatch for PET extrusion foaming according to claim 1, wherein an intrinsic viscosity of the PBT is 0.75-1.3 dL/g.

4. The chain extender masterbatch for PET extrusion foaming according to claim 3, wherein the intrinsic viscosity of the PBT is 0.90-1.20 dL/g.

5. The chain extender masterbatch for PET extrusion foaming according to claim 1, wherein a melt flow rate of the POE is 0.5-5 g/10 min, and a melt flow rate of glycidyl methacrylate grafted polyolefin elastomer (POE-g-GMA) is 1-5 g/10 min.

6. The chain extender masterbatch for PET extrusion foaming according to claim 5, wherein the melt flow rate of the POE is 0.5-1.5 g/10 min, and the melt flow rate of the POE-g-GMA is 2-5 g/10 min.

7. The chain extender masterbatch for PET extrusion foaming according to claim 1, wherein a grafting ratio of glycidyl methacrylate (GMA) in glycidyl methacrylate grafted polyolefin elastomer (POE-g-GMA) is 0.2-5%.

8. The chain extender masterbatch for PET extrusion foaming according to claim 7, wherein the grafting ratio of the GMA in the POE-g-GMA is 0.5-2%.

9. A preparation method for the chain extender masterbatch for PET extrusion foaming according to claim 1, comprising the following steps:
(1) weighing the following components in parts by weight: 5-30 parts of the PMDA, 25-90 parts of the PBT, and 5-70 parts of the POE+POE-g-GMA, wherein the POE accounts for 0-85% of the POE+POE-g-GMA; and
(2) feeding above components into an extruder, mixing at a mixing temperature higher than a melting temperature of the PBT by 5-25° C. and lower than a melting temperature of a chain extender by 20-100° C. and a screw speed of 100-500 rpm, and granulating.

10. Use of the chain extender masterbatch for PET extrusion foaming according to claim 1 in a PET extrusion foaming process, with one or more PET raw materials selected from a group consisting of fiber grade PET, film grade PET, bottle grade PET, engineering plastic grade PET, and recycled PET, wherein an intrinsic viscosity of the PET is 0.5-1.5 dL/g, an end carboxyl group concentration of the PET is 15-50 mol/t, an amount of the chain extender masterbatch added in a process of PET extrusion foaming is 0.5-10 wt % by mass.

11. Use of a chain extender masterbatch for PET extrusion foaming prepared by the preparation method of the chain extender masterbatch for PET extrusion foaming according to claim 9 in a PET extrusion foaming process, with one or more PET raw materials selected from a group consisting of fiber grade PET, film grade PET, bottle grade PET, engineering plastic grade PET, and recycled PET, wherein an intrinsic viscosity of the PET is 0.5-1.5 dL/g, an end carboxyl group concentration of the PET is 15-50 mol/t, an amount of the chain extender masterbatch added in a process of PET extrusion foaming is 0.5-10 wt % by mass.
